(19) United States
(12) Patent Application Publication
(10) Pub. No.: US 2007/0033286 A1
(43) Pub. Date: Feb. 8, 2007

(54) Method for setting media streaming parameter of upnp-based network

(76) Inventor: Ku-Bong Min, Seoul (KR)

Correspondence Address: Jonathan Y Kang;Lee Hong Degerman Kang & Schmadeka, 14th Floor, 801 South Figueroa Street, Los Angeles, CA, 90017, US

(21) Appl. No.: 10/571,951

(22) PCT Filed: Sep. 9, 2004
(86) PCT No.: PCT/KR04/02297

§ 371 Date: Mar. 13, 2006

(30) Foreign Application Priority Data
Sep. 15, 2003 (KR) 10-2003-0063785

(51) Int. Cl. G06F 15/16

(52) U.S. Cl. 709/228

(57) ABSTRACT

The present invention discloses a method for setting media streaming parameters on a UPnP-based network which can improve quality of media. The method for setting the media streaming parameters on the UPnP-based network can improve media playing quality and efficiently use resources of each device, by allowing an AV control point to monitor states of UPnP devices regardless of a media transfer protocol, transmit traffic transfer parameters for optimum quality of media to each UPnP device, and automatically set optimum parameters or make each UPnP device set the optimum parameters upon the user's request.

### TECHNICAL FIELD

The present invention relates to a Universal Plug and Play (UPnP)-based network, and more particularly to, a method for setting media streaming parameters on a UPnP-based network which can optimally improve quality of media.

### BACKGROUND ART

According to development of information technologies, various IT products such as cellular phones, digital TV sets, PDAs and game machines as well as PCs are connected to a network as home network devices. As such a network environment is extended to houses, a home network gains popularity. Especially, the UPnP gets influential in integration, control and administration of the home network devices.

The UPnP is a common protocol prepared by adding a plug and play function to a general operating system, so that various network devices of different standards and specifications can interface each other. That is, the UPnP is expanded to the whole network on the basis of internet standard technologies such as the TCP/IP, HTTP and XML, so that network devices such as home appliances, network printers and internet gateways can network each other.

The basic structure of the UPnP consists of a device, a service and a control point (CP).

The device includes a service and a few sub-devices. For example, a VCR device may be comprised of a tape transfer service, a tuner service and a time service. The service implies the smallest small-scale control unit on the network, and is modeled by state variables. The CP implies a controller having functions of sensing and controlling the other devices. Therefore, the user can discover, describe and control various devices or receive an event through the interface provided by the CP.

The UPnP is embodied on the basis of the standards defined by the UPnP forum (http://www.UPnP.org) according to UPnP Device Architecture 1.0 widely distributed by Microsoft Corporation. The UPnP forum that leads establishment of the standards of the UPnP devices and services consists of six working groups. Among the six working groups, the AN (audio/video) working group includes and standardizes a control point which is a UPnP device based on the UPnP AV Architecture (hereinafter, referred to as ‘AV CP’), a media server (MS) and a media renderer (MR).

FIG. 1 is a block diagram illustrating a structure of a general UPnP AV.

Referring to FIG. 1, in accordance with the current standards of UPnP AV Architecture 1.0, the structure of the UPnP AV consists of an MS 120 for providing media data to a home network, an MR 130 for playing the media data through the home network, and an AV CP 110 for controlling the MS 120 and the MR 130.

The operation of the general UPnP AV will now be explained.

The AV CP 110 controls the UPnP devices (MS and MR) by calling actions provided by a simple object access protocol (SOAP) device that is a standardized protocol. In addition, the AV CP 110 joins event services provided by the UPnP devices, and receives state information changes of the UPnP devices.

The MS 120 provides a content directory service 121 for providing a media data search service, a connection manager service 122 for managing connection for streaming between the MS 120 and the MR 130, and an AV transport service 123 for providing controls such as play and stop of media.

The MR 130 provides a rendering control service 131 for controlling brightness of screen, a connection manager service 132 for managing connection for streaming between the MS 120 and the MR 130, and an AV transport service 133 for providing controls such as play and stop of media.

Accordingly, in regard to the MS 120 and the MR 130 discovered on the network, the AV CP 110 obtains media data information of the MS 120 by using the content directory service 121, performs connection for media transmission between the MS 120 and the MR 130 through the connection manager services 122 and 132 on the basis of the information, and plays the corresponding media file by using the AV transport services 123 and 133.

As described above, the UPnP AV discovers the media information, prepares connection for streaming, and helps execution of streaming. The actual media data transmission is performed through an out-of-band transfer protocol 142. That is, in order to play the media data, the general UPnP AV transmits the media data between the MS 120 and the MR 130 by streaming. Since a variety of publicly-known streaming methods can be adopted, the UPnP AV does not determine the specific streaming method but utilizes the out-of-band transfer protocol 142. For example, when an RTP is used for media transmission, a transmission state of media data can be monitored through an RTCP, and transmission parameters can be adjusted on the basis of the monitored state.

The network state may be often changed due to various variables. It is thus necessary to buffer the media data, correct errors and set Codec in the MS 120 and the MR 130 according to the streaming methods. In order to play the media with high quality and efficiently use resources of each device, the MS 120 and the MR 130 need to notify their states to each other.

However, the general UPnP AV does not support information on quality of the transmitted media data, packet loss and delay, and a data buffer used in the system.

### DISCLOSURE OF THE INVENTION

Therefore, an object of the present invention is to provide a method for setting media streaming parameters on a UPnP-based network which can improve quality of media, by allowing an AV CP to monitor states of UPnP devices regardless of a media transfer protocol, transmit traffic transfer parameters for optimum quality of media to each UPnP device, and automatically set optimum parameters or make each UPnP device set the optimum parameters upon the user's request.

To achieve these and other advantages and in accordance with the purpose of the present invention, as embodied and broadly described herein, there is provided a method for setting media streaming parameters on a UPnP-based network, including the steps of: collecting streaming parameter information by monitoring states of UPnP devices; and setting parameters of the UPnP devices, by providing state information of the UPnP devices to each other on the basis of the collected streaming parameter information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a structure of a general UPnP AV;

FIG. 2 is a block diagram illustrating a structure of a UPnP AV network in accordance with the present invention;

FIG. 3 is a table showing state variables of a sink control service in accordance with the present invention;

FIG. 4 is a table showing actions for the sink control service in accordance with the present invention;

FIG. 5 is a table showing state variables of a source control service in accordance with the present invention;

FIG. 6 is a table showing actions for the source control service in accordance with the present invention; and

FIG. 7 is a flowchart showing sequential steps of a method for setting streaming parameters in accordance with the present invention.

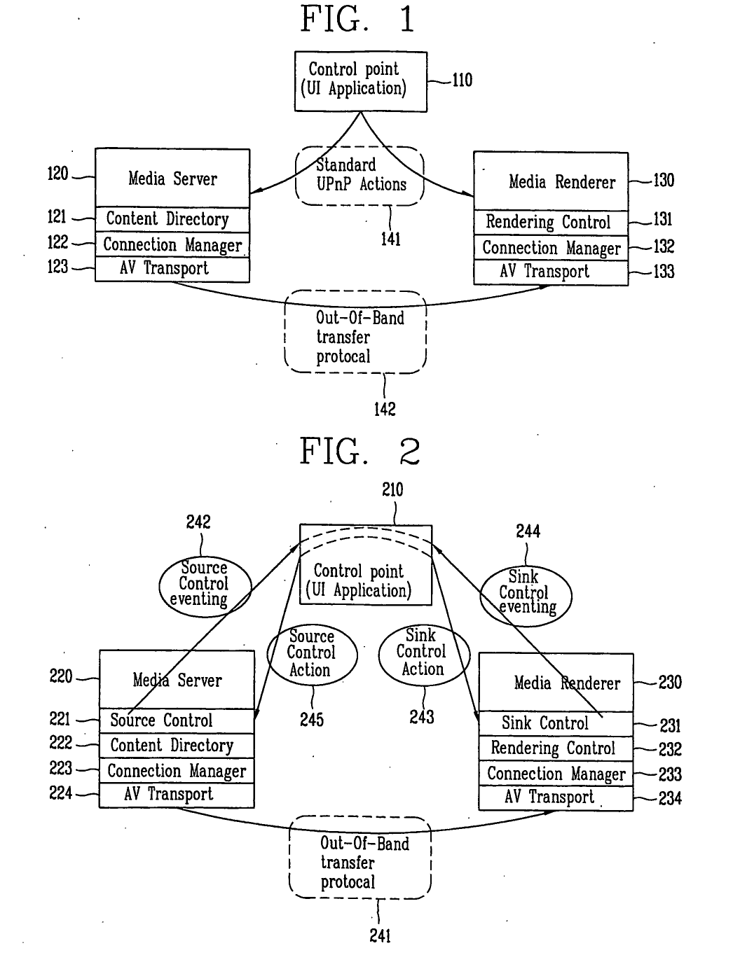

### MODES FOR CARRYING OUT THE PREFERRED EMBODIMENTS

Reference will now be made in detail to the preferred embodiments of the present invention, examples of which are illustrated in the accompanying drawings.

In accordance with the present invention, on a UPnP AV network, a media server (MS) or a media renderer (MR) is an independent service for setting parameters, and uses UPnP state variables and actions. Here, the UPnP state variables include state variables of a source control service and state variables of a sink control service, and the actions include actions for the source control service and actions for the sink control service. The state variables and the actions are added to and defined in the MS and the MR.

A method for setting media streaming parameters on the UPnP AV network which can maintain optimum quality of media in accordance with the preferred embodiments of the present invention will now be described in detail with reference to the accompanying drawings.

FIG. 2 is a block diagram illustrating the structure of the UPnP AV network in accordance with the present invention.

As illustrated in FIG. 2, the UPnP AV network includes an MS 220 consisting of a source control service 221, a content directory service 222, a connection manger service 223 and an AV transport service 224, and providing media data, an MR 230 consisting of a sink control service 231, a rendering control service 232, a connection manager service 233 and an AV transport service 234, and playing the media data from the MS 220, and an AV control point (AV CP) 210 for setting optimum streaming parameters between the MS 220 and the MR 230, by joining event services or calling actions.

The operation of the UPnP AV network will now be explained.

The AV CP 210 monitors various streaming parameters and network states, by joining events of the source control service 221 of the MR 220 and the sink control service 231 of the MR 230. In addition, the AV CP 210 can discover the streaming parameters and the network states in a wanted time through a get sink parameters action for the sink control service 231 and a get source parameters action for the source control service 221.

Thereafter, the AV CP 210 intelligently composes optimum parameter setting on the basis of the discovered streaming parameters and network states, and dynamically designates various parameters through setup sink parameters and setup source parameters actions for the sink control service 231 and the source control service 221.

On the other hand, the AV CP 210 transmits the information of the sink control service 231 of the MR 230 and the source control service 221 of the MS 220 to each other, by calling report source parameters and report sink parameters actions. Thus, the source control service 221 and the sink control service 231 compose the optimum streaming parameters on the basis of the received values.

The structure and operational effects of the present invention will now be explained in more detail.

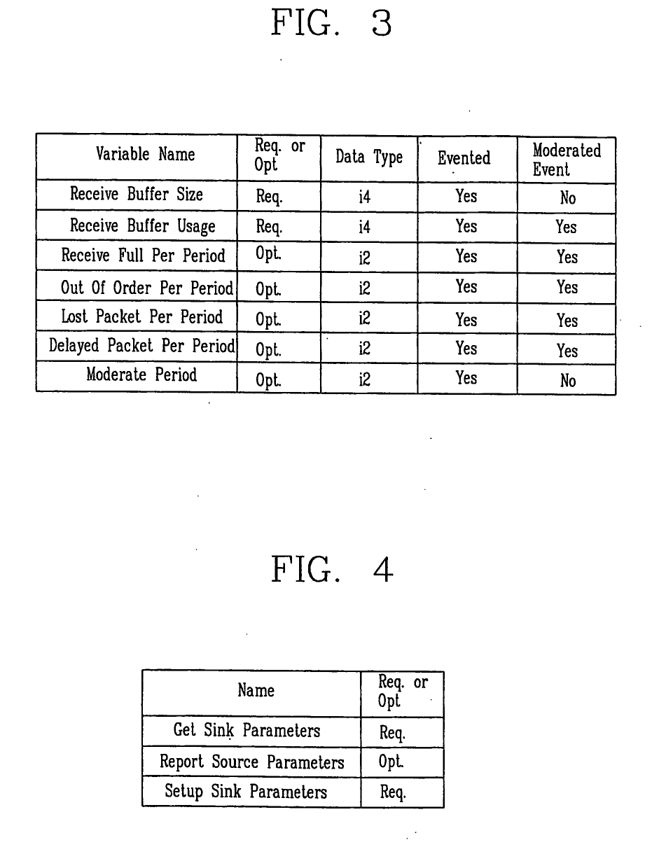

FIG. 3 is a table showing the state variables of the sink control service in accordance with the present invention.

FIG. 4 is a table showing the actions for the sink control service in accordance with the present invention.

As shown in FIGS. 3 and 4, the UPnP variables and actions are defined as follows as the service for the MR 230.

The UPnP variables and actions which compose an independent service for enabling the MR 230 to receive a media stream state report and adjust parameters can be directly included in the MR 230, or added to the general AV transport service 234 or the connection manager service 233 as vendor-specific actions and state variables. If necessary, a new UPnP device is defined, registered as a service, and included in the MR 230 as an embedded device.

For example, still referring to FIG. 3, it is presumed that the sink control service 231 is newly defined in the MR 230. Here, the state variables of the sink control service 231 consist of a receive buffer size, a receive buffer usage, a buffer full per period, an out of order per period, a lost packet per period, a delayed packet per period and a moderate period.

The receive buffer size indicates a size of a receive buffer set in the MR 230 to play media streams. The receive buffer usage shows how many data are filled in the receive buffer. It is obtained by measuring a value in an eventing time point or calculating an average for a predetermined period. The buffer full per period implies how many times the buffer is fully filled in the recent moderate period. The out of order per period indicates a number of out of order packets in the recent moderate period. The lost packet per period shows a number of lost packets in the recent moderate period. The delayed packet per period indicates a number of delayed and wasted packets in the recent moderate period. The moderate period is a counting period of each variable. All the variables are initialized and re-calculated at the initial stage of each period. Here, ‘Req.’ denotes an essential variable, ‘Opt.’ denotes a selective variable, ‘evented’ denotes eventing/non-eventing for the CPs joining the event by state changes of the variables, and ‘moderate event’ denotes collective eventing after a predetermined period.

Also, still referring to FIG. 4, the actions for the sink control service consist of get sink parameters, report source parameters and setup sink parameters.

When the AV CP 210 calls the get sink parameters action, the sink control service 231 transmits its whole state variables as return values. When the AV CP 210 calls the report source parameters action, the AV CP 210 can transmit the parameters of the source control service 221 of the MS 220 to the sink control service 231 of the MR 230. That is, the AV CP 210 transmits the state variables as input arguments of the action.

In the case that the AV CP 210 intends to set appropriate parameters for the sink control service 231 of the MR 230 on the basis of various information from the source control service 221 of the MS 220 and the sink control service 231 of the MR 230, the AV CP 210 adjusts the streaming parameters of the MR 230 by calling the setup sink parameters action.

At last, if parameters that need to be additionally reported and adjusted exist according to the streaming methods, the AV CP 210 expands the parameters through the vender-specific state variables and actions.

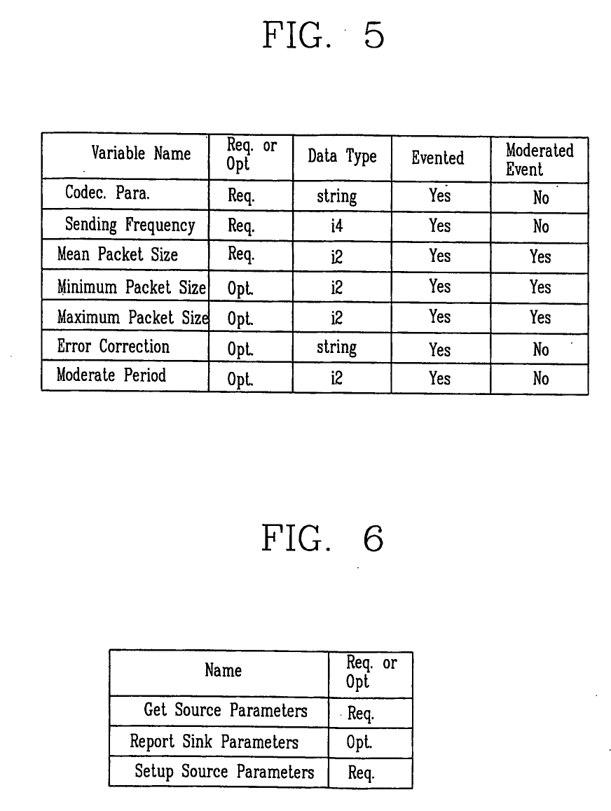

FIG. 5 is a table showing the state variables of the source control service in accordance with the present invention.

FIG. 6 is a table showing the actions for the source control service in accordance with the present invention.

As depicted in FIGS. 5 and 6, the UPnP variables and actions are defined as follows as the service for the MS 220.

The UPnP variables and actions which compose an independent service for enabling the MS 220 to receive a media stream state report and adjust parameters can be directly included in the MS 220, or added to the general AV transport service 224 or the connection manager service 223 as vendor-specific actions and state variables.

If necessary, a new UPnP device is defined, registered as a service, and included in the MS 220 as an embedded device.

For example, still referring to FIG. 5, it is presumed that the source control service 221 is newly defined in the MS 220. Here, the state variables of the source control service 221 consist of Codec. Para., a sending frequency, a mean packet size, a minimum packet size, a maximum packet size, error correction and a moderate period.

The Codec. Para. implies an encoding method of the media data in the MS 220 and parameters. For example, the Codec. Para. indicates a kind of a coding algorithm, a compression ratio, a number of frames per second and definition, and consists of strings. The sending frequency shows how many times packets are created and transmitted for one second. The mean packet size indicates a mean size of the packets generated in the recent moderate period. The minimum packet size indicates a size of the minimum packet among the packets generated in the recent moderate period. The maximum packet size indicates a size of the maximum packet among the packets generated in the recent moderate period. The error correction shows support/non-support of error correction mechanism, a kind of used mechanism and corresponding parameters. For example, the error correction provides use/non-use and a number of retransmission, use/non-use of forward error correction (FEC), and corresponding parameters. The moderate period is a counting period of each variable. All the variables are initialized and recalculated at the initial stage of each period. Here, ‘Req.’ denotes an essential variable, ‘Opt.’ denotes a selective variable, ‘evented’ denotes eventing/non-eventing for the CPs joining the event by state changes of the variables, and ‘moderate event’ denotes collective eventing after a predetermined period.

Also, still referring to FIG. 6, the actions for the source control service 221 consist of get source parameters, report sink parameters and setup source parameters.

When the AV CP 210 calls the get source parameters action, the source control service 221 transmits its whole state variables as return values.

When the AV CP 210 calls the report sink parameters action, the AV CP 210 can transmit the parameters of the sink control service 231 of the MR 230 to the source control service 221 of the MS 220. That is, the AV CP 210 transmits the state variables as input arguments of the action.

In the case that the AV CP 210 intends to set appropriate parameters for the source control service 221 of the MS 220 on the basis of various information from the source control service 221 of the MS 220 and the sink control service 231 of the MR 230, the AV CP 210 adjusts the streaming parameters of the IMS 220 by calling the setup source parameters action.

At last, if parameters that need to be additionally reported and adjusted exist according to the streaming methods, the AV CP 210 expands the parameters through the vender-specific state variables and actions.

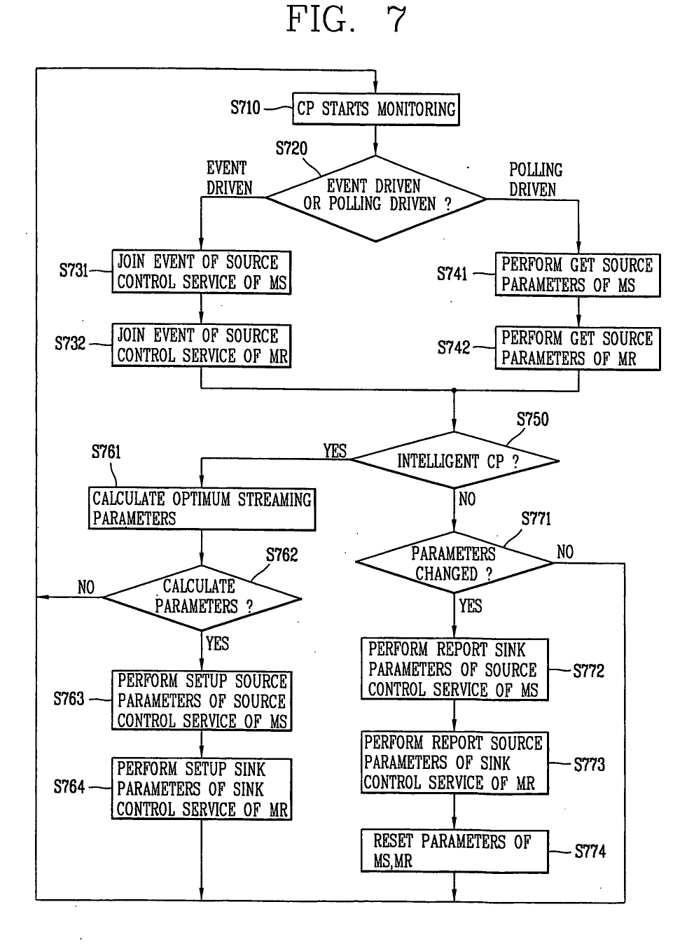

FIG. 7 is a flowchart showing sequential steps of the method for setting the streaming parameters on the UPnP-based network in accordance with the present invention.

The method for setting the media streaming parameters on the UPnP-based network includes the steps of monitoring the states of the MS 220 and the MR 230 (namely, the UPnP devices) by the AV CP 210, collecting traffic quality information and streaming parameter information of the MS 220 and the MR 230, and re-setting the parameters of the MS 220 and the MR 230 on the basis of the collected information, and repeating the above procedure.

The method for setting the media streaming parameters in accordance with the present invention will now be described in more detail with reference to FIG. 7.

As shown in FIG. 7, the AV CP 210 discovers the MS 220 supporting the source control service 221 and the MR 230 supporting the sink control service 231, starts streaming and performs monitoring (S710).

Exemplary methods for confirming the streaming parameters by the AV CP 210 include an event driven method using event joining, and a polling method periodically calling an action. Therefore, the AV CP 210 determines whether to use the event driven method or the polling method (S720).

When the AV CP 210 selects the event driven method, the AV CP 210 joins the event of the source control service 221 of the MS 220, and also joins the event of the sink control service 231 of the MR 230.

On the other hand, when the AV CP 210 uses the polling method, if the AV CP 210 calls the get source parameters action for the source control service 221 of the MS 220, the source control service 221 transmits its whole state variables as return values (S741), and if the AV CP 210 calls the get sink parameters action for the sink control service 231 of the MR 230, the sink control service 231 transmits its all state variables as return values (S742). Accordingly, the AV CP 210 can collect network traffic quality information and various streaming parameter information.

It is determined whether the AV CP 210 (namely, an intelligent CP) directly calculates the optimum parameters on the basis of the collected network traffic quality information and various streaming parameter information, or transmits the collected information to the MS 220 and the MR 230 (namely, each UPnP device) so that the MS 200 and the MR 230 can calculate the streaming parameter information, respectively (S750).

In the case that the AV CP 210 directly intelligently calculates the optimum parameters, the AV CP 210 calculates the optimum streaming parameters (S761), and checks whether the optimum streaming parameters are different from the structures of the MS 220 and the MR 230 (S762). Here, if the optimum streaming parameters are different from the structures of the MS 220 and the MR 230, the AV CP 210 adjusts the streaming parameters of the MS 220 by performing the setup source parameters action for the source control service 221 of the MS 220 (S762), and also adjusts the streaming parameters of the MR 230 by calling the setup sink parameters action for the sink control service 231 of the MR 230 (S763).

On the other hand, when the UPnP devices calculate the streaming parameter information, respectively, the AV CP 210 firstly confirms whether the previous streaming parameters are different from the new streaming parameters (S771). If the previous streaming parameters are different from the new streaming parameters, the AV CP 210 provides the parameters of the sink control service 231 of the MR 230 to the source control service 221 of the MS 220, by calling the report sink parameters action for the source control service 221 of the MS 220 (S772), and also provides the parameters of the source control service 221 of the MS 220 to the sink control service 231 of the MR 230, by calling the report source parameters action for the sink control service 231 of the MR 230 (S773). That is, the AV CP 210 transmits the parameter information of the MS 220 and the MR 230 (each UPnP device) to each other, respectively.

The MS 220 and the MR 230 calculate and set new parameters according to the received information, respectively.

At last, after finishing the above operations, the AV CP 210 newly performs monitoring (S710).

As discussed earlier, in accordance with the present invention, the method for setting the media streaming parameters on the UPnP-based network can cut down expenses, improve media playing quality, and efficiently use resources of each device, by allowing the AV CP to monitor the states of the UPnP devices regardless of the media transfer protocol, transmit the traffic transfer parameters for optimum quality of media to each UPnP device, and automatically set the optimum parameters or make each UPnP device set the optimum parameters upon the user's request.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. In a Universal Plug and Play (UPnP)-based network system consisting of UPnP devices such as a media server and a media renderer, and an AV control point (AV CP) for controlling the UPnP devices, and performing streaming transmission for playing media, a method for setting media streaming parameters on a UPnP-based network, comprising the steps of:
collecting streaming parameter information by monitoring states of the UPnP devices; and
setting parameters of the UPnP devices, by providing state information of the UPnP devices to each other on the basis of the collected streaming parameter information.

2. The method of claim 1, which collects the streaming parameter information by using any one of an event driven method using event joining and a polling method periodically calling an action.

3. The method of claim 2, wherein the event driven method is driven whenever the streaming parameters are changed, or driven by searching the streaming parameters for a predetermined period and calculating an average thereof.

4. The method of claim 1, wherein the parameters are set by using any one of a method for directly setting optimum parameters by the AV CP, and a method for transmitting the streaming parameter information to the UPnP devices and setting parameters by the UPnP devices.

5. The method of claim 4, wherein the method for setting the parameters by the AV CP comprises the steps of:
calculating, at the AV CP, the optimum streaming parameters;
confirming whether the calculated streaming parameters are identical to the current parameters of the UPnP devices; and
transmitting the calculated parameters to the UPnP devices, and re-setting the current parameters.

6. The method of claim 5, which adjusts the parameters of the media server by calling a setup source parameters action for a source control service of the media server, and re-sets the streaming parameters of the media renderer by calling a setup sink parameters action for a sink control service of the media renderer.

7. The method of claim 4, wherein the method for setting the parameters by the UPnP devices comprises the steps of:
confirming, at the AV CP, whether the previous streaming parameters are different from the new streaming parameters;
transmitting, at the AV CP, the parameter information of the UPnP devices to each other; and
setting, at the UPnP devices, new parameters on the basis of the received parameter information.

8. The method of claim 7, wherein, in the step for transmitting the parameter information, the AV CP provides the parameters of the sink control service of the media renderer to the source control service of the media server by calling a report sink parameters action for the source control service of the media server, and provides the parameters of the source control service of the media server to the sink control service of the media renderer by calling a report source parameters action for the sink control service of the media renderer.

9. The method of claim 1, wherein the media server or the media renderer which composes an independent service for setting the parameters uses UPnP state variables and actions.

10. The method of claim 9, wherein the UPnP state variables comprise state variables of the source control service and state variables of the sink control service, and the actions comprise actions for the source control service and actions for the sink control service.

11. The method of claim 10, wherein the state variables of the sink control service comprise:
a receive buffer size indicating a size of a receive buffer set in the media renderer to play media streams;
a receive buffer usage indicating how many data are filled in the receive buffer;
a moderate period indicating a counting period of each variable;
a buffer full per period indicating how many times the buffer is fully filled in the moderate period;
an out of order per period indicating a number of out of order packets in the moderate period;
a lost packet per period indicating a number of lost packets in the moderate period; and
a delayed packet per period indicating a number of delayed and wasted packets in the moderate period.

12. The method of claim 10, wherein the actions for the sink control service comprise:
get sink parameters for allowing the sink control service to transmit its whole state variables to the AV CP as return values;
report source parameters for allowing the AV CP to provide the parameters of the source control service of the media server to the sink control service of the media renderer; and
setup sink parameters for adjusting the streaming parameters of the media renderer.

13. The method of claim 10, wherein the state variables of the source control service comprise:
Codec. Para. indicating an encoding method of media data in the media server and parameters;
a sending frequency indicating how many times packets are created and transmitted for one second;
a moderate period indicating a counting period of each variable;
a mean packet size indicating a mean size of the packets generated in the moderate period;
a minimum packet size indicating a size of the minimum packet among the packets generated in the moderate period;
a maximum packet size indicating a size of the maximum packet among the packets generated in the moderate period; and
error correction indicating support/non-support of error correction mechanism, a kind of used mechanism and corresponding parameters.

14. The method of claim 10, wherein the actions for the source control service comprise:
get source parameters for allowing the source control service to transmit its whole state variables to the AV CP as return values according to the call from the AV CP;
report sink parameters for allowing the AV CP to transmit the parameters of the sink control service of the media renderer to the source control service of the media server; and
setup source parameters for adjusting the streaming parameters of the media server.

15. In a Universal Plug and Play (UPnP)-based network system consisting of UPnP devices such as a media server and a media renderer, and an AV control point (AV CP) for controlling the UPnP devices, and performing streaming transmission for playing media, a method for setting media streaming parameters on a UPnP-based network, comprising the steps of:
monitoring states of the media server and the media renderer by the AV CP;
collecting traffic quality information and streaming parameter information of the media server and the media renderer; and
setting parameters of the media server and the media renderer on the basis of the collected information, and repeating the above procedure.

16. The method of claim 15, wherein, in the monitoring step, the AV CP discovers the media server supporting a source control service and the media renderer supporting a sink control service, starts streaming, and performs monitoring.

17. The method of claim 15, which collects the traffic quality information and the streaming parameter information by using any one of an event driven method using event joining and a polling method periodically calling an action.

18. The method of claim 17, wherein the event driven method comprises the steps of:
joining an event of the source control service of the media server; and
joining an event of the sink control service of the media renderer.

19. The method of claim 17, wherein the polling method comprises the steps of:
calling, at the AV CP, a get source parameters action for the source control service of the media server, and providing, at the source control service, its whole state variables as return values; and
calling, at the AV CP, a get sink parameters action for the sink control service of the media renderer, and providing, at the sink control service, its whole state variables as return values.

20. The method of claim 15, wherein the parameters are set by using any one of a method for directly setting parameters by the AV CP on the basis of the collected traffic quality information and streaming parameter information, and a method for transmitting the information to the media server and the media renderer, and setting parameters by the media server and the media renderer, respectively.

21. The method of claim 20, wherein the method for setting the parameters by the AV CP sets the parameters by calculating the optimum streaming parameters by the AV CP, and confirming whether the calculated optimum streaming parameters are different from the current structures of the media server and the media renderer.

22. The method of claim 21, wherein the method for setting the parameters by the AV CP comprises the steps of:
adjusting the streaming parameters of the media server by performing a setup source parameters action for the source control service of the media server; and
adjusting the streaming parameters of the media renderer by calling a setup sink parameters action for the sink control service of the media renderer.

23. The method of claim 20, wherein the method for setting the parameters by the media server and the media renderer confirms whether the previous streaming parameters are different from the new streaming parameters by the AV CP, and transmits the parameter information of the media server and the media renderer to each other.

24. The method of claim 23, wherein the step for transmitting the parameter information comprises the steps of:
transmitting, at the AV CP, the parameters of the sink control service of the media renderer to the source control service of the media server by calling a report sink parameters action for the source control service of the media server; and
transmitting, at the AV CP, the parameters of the source control service of the media server to the sink control service of the media renderer by calling a report source parameters action for the sink control service of the media renderer.
